(19) United States
(12) Patent Application Publication
(10) Pub. No.: US 2023/0206578 A1
(43) Pub. Date: Jun. 29, 2023

(54) METHOD FOR GENERATING VIRTUAL CHARACTER, ELECTRONIC DEVICE AND STORAGE MEDIUM

(71) Applicant: Beijing Baidu Netcom Science Technology Co., Ltd., Beijing (CN)

(72) Inventors: Jie LI, Beijing (CN); Chen ZHAO, Beijing (CN)

(21) Appl. No.: 18/181,371

(22) Filed: Mar. 9, 2023

(30) Foreign Application Priority Data
Mar. 11, 2022 (CN) 202210244262.7

(51) Int. Cl. G06T 19/20; G06T 17/20

(52) U.S. Cl. CPC G06T 19/20; G06T 17/20; G06T 2219/2012

(57) ABSTRACT

A method for generating a virtual character is provided, relating to a field of artificial intelligence technology, and in particular, to fields of computer vision, virtual/augmented reality and meta universe technologies. The implementation includes: converting a plurality of points of an initial three-dimensional virtual character into a frequency domain, so as to obtain a plurality of frequency domain points; rendering the plurality of frequency domain points, so as to generate a first three-dimensional virtual character; determining a perceptual feature of the first three-dimensional virtual character; and generating a second three-dimensional virtual character according to a difference between the perceptual feature and a predetermined style feature. An electronic device and a storage medium are also provided.

### CROSS-REFERENCE TO RELATED APPLICATIONS

This application is claims priority to Chinese Application No. 202210244262.7 filed on Mar. 11, 2022, which is incorporated herein by reference in its entirety.

### TECHNICAL FIELD

The present disclosure relates to a field of artificial intelligence technology, and in particular to fields of computer vision, virtual/augmented reality and meta universe technologies, which may be applied to image processing scenes. Specifically, the present disclosure provides a method for generating a virtual character, an electronic device, and a storage medium.

### BACKGROUND

Virtual characters have a wide range of applications in scenes such as metaverse, social networking, live streaming, or gaming. The virtual character may be generated artificially.

### SUMMARY

The present disclosure provides a method for generating a virtual character, an electronic device and a storage medium.

According to an aspect of the present disclosure, a method for generating a virtual character is provided, including: converting a plurality of points of an initial three-dimensional virtual character into a frequency domain, so as to obtain a plurality of frequency domain points; rendering the plurality of frequency domain points, so as to generate a first three-dimensional virtual character; determining a perceptual feature of the first three-dimensional virtual character; and generating a second three-dimensional virtual character according to a difference between the perceptual feature and a predetermined style feature.

According to another aspect of the present disclosure, an electronic device is provided, including: at least one processor; and a memory communicatively connected with the at least one processor; wherein the memory stores instructions executable by the at least one processor, and the instructions, when executed by the at least one processor, cause the at least one processor to perform the method provided by the present disclosure.

According to another aspect of the present disclosure, a non-transitory computer-readable storage medium storing computer instructions is provided, wherein the computer instructions are configured to cause the computer to perform the method provided by the present disclosure.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the present solution, and do not constitute a limitation to the present disclosure. Wherein:

FIG. 1 is a schematic diagram of an exemplary system architecture in which a method and an apparatus for generating a virtual character may be applied according to an embodiment of the present disclosure;

FIG. 2 is a flowchart of a method for generating a virtual character according to an embodiment of the present disclosure;

FIG. 3 is a flowchart of a method for generating a virtual character according to an embodiment of the present disclosure;

FIG. 4 is a flowchart of a method for generating a virtual character according to an embodiment of the present disclosure;

FIG. 5 is a block diagram of an apparatus for generating a virtual character according to an embodiment of the present disclosure; and

FIG. 6 is a block diagram of an electronic device in which a method for generating a virtual character may be applied according to an embodiment of the present disclosure.

### DETAILED DESCRIPTION OF EMBODIMENTS

The following describes exemplary embodiments of the present disclosure with reference to the drawings, which include various details of the embodiments of the present disclosure to facilitate understanding, and should be regarded as merely exemplary. Therefore, those skilled in the art should recognize that various changes and modifications may be made to the embodiments described herein without departing from the scope and spirit of the present disclosure. Likewise, for clarity and conciseness, descriptions of well-known functions and structures are omitted in the following description.

A virtual character may include a virtual body. A virtual character may be designed, generated, and optimized artificially, which requires a high time cost. Moreover, the virtual character generated artificially has small number of style(s).

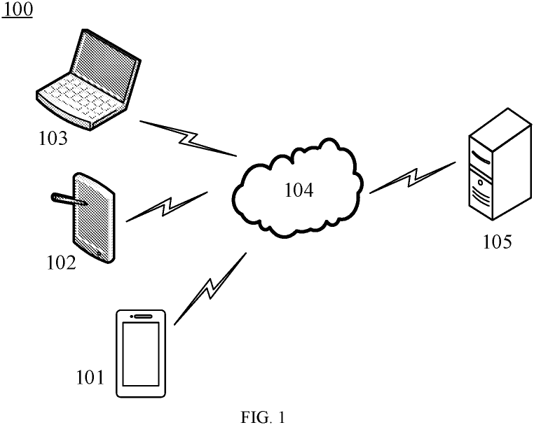

FIG. 1 is a schematic diagram of an exemplary system architecture in which a method and an apparatus for generating a virtual character may be applied according to an embodiment of the present disclosure. It should be noted that FIG. 1 is only an example of a system architecture to which the embodiments of the present disclosure may be applied, so as to help those skilled in the art to understand the technical content of the present disclosure, but it does not mean that the embodiments of the present disclosure may not be used for other devices, systems, environments or scenes.

As shown in FIG. 1, a system architecture 100 according to this embodiment may include terminal devices 101, 102, 103, a network 104 and a server 105. The network 104 is used to provide a medium of a communication link between the terminal devices 101, 102, 103 and the server 105. The network 104 may include various types of connections, such as wired and/or wireless communication links, and the like.

A user may use the terminal devices 101 to interact with the server 103 through the network 102, so as to receive or send messages and the like. The terminal devices 101, 102, 103 may be various electronic devices having display screens and supporting web browsing, including but not limited to smart phones, tablet computers, laptop computers, desktop computers and the like.

The server 105 may be a server that provides various services, such as a background management server (just an example) that provides support for the content browsed by the user using the terminal devices 101, 102, and 103. The background management server may analyze and process the received user request and other data, and feedback the processing result (such as web pages, information, or data obtained or generated according to user request) to the terminal device.

It should be noted that, the method for generating a virtual character provided by the embodiments of the present disclosure may be generally performed by the server 105. Correspondingly, the apparatus for generating a virtual character provided by the embodiments of the present disclosure may generally be provided in the server 105. In some examples, the method for generating a virtual character provided by the embodiments of the present disclosure may be performed by a server or a cluster of servers that is different from the server 105 and may communicate with the terminal devices 101, 102, 103 and/or the server 105. Correspondingly, in some examples, the apparatus for generating a virtual character provided by the embodiments of the present disclosure may be provided in a server or server cluster that is different from the server 105 and may communicate with the terminal devices 101, 102, 103 and/or the server 105.

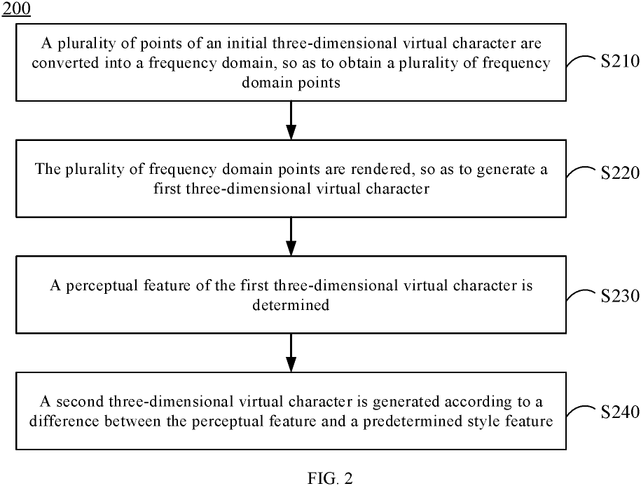

FIG. 2 is a flowchart of a method for generating a virtual character according to an embodiment of the present disclosure.

As shown in FIG. 2, the method 200 may include operation S210 to operation S240.

In operation S210, a plurality of points of an initial three-dimensional virtual character are converted into a frequency domain, so as to obtain a plurality of frequency domain points.

For example, the initial three-dimensional virtual character may be a preset three-dimensional virtual character.

For example, Fourier transform may be performed on the plurality of points of the initial three-dimensional virtual character, so as to convert the plurality of points into the frequency domain.

In operation S220, the plurality of frequency domain points are rendered, so as to generate a first three-dimensional virtual character.

For example, the plurality of frequency domain points may be rendered by using various renderers. In an example, the plurality of frequency domain points may be rendered by using a Pytorch3D renderer.

In operation S230, a perceptual feature of the first three-dimensional virtual character is determined.

For example, the perceptual feature of the first three-dimensional virtual character may be determined according to various feature extraction models.

In operation S240, a second three-dimensional virtual character is generated according to a difference between the perceptual feature and a predetermined style feature.

For example, a feature extraction may be performed on acquired style description information by using various feature extraction models, so as to obtain the predetermined style feature.

For example, a difference value between the perceptual feature and the predetermined style feature may be determined according to various loss functions. In an example, the difference value between the perceptual feature and the predetermined style feature may be determined according to L2 loss function. If the difference value satisfies a predetermined condition, the above-mentioned first three-dimensional virtual character may be determined as the second three-dimensional virtual character. If the difference value does not satisfy the predetermined condition, the above-mentioned first three-dimensional virtual character may be adjusted until the difference value between the perceptual feature and the predetermined style feature satisfies the predetermined condition. For example, the predetermined condition may be that the difference value is smaller than a predetermined threshold.

Through the embodiments of the present disclosure, a three-dimensional virtual character matching the predetermined style feature may be generated.

In some embodiments, the first three-dimensional virtual character may be processed by using a contrastive language-image pre-training model, so as to obtain the perceptual feature of the first three-dimensional virtual character.

For example, the contrastive language-image pre-training (CLIP) model may extract a feature of a text. It is also possible to extract a feature of an image by using the CLIP model. The contrastive language-image pre-training model is an open-source general model that connects text and image. The task that needs to be completed by the contrastive image-text pre-training model is to identify various visual information in image and associate the information with one of massive pictures.

In an example, a screenshot operation may be performed on a display screen displaying the first three-dimensional virtual character, so as to obtain a screenshot image. The screenshot image is processed by using the contrastive image-text pre-training model to obtain a perceptual feature.

In some embodiments, the predetermined style feature is determined according to the style description information by using the contrastive language-image pre-training model.

For example, a text input by a target object may be obtained, and the text may be taken as style description information. Next, the style description information may be processed by using the above-mentioned contrastive language-image pre-training model, so as to determine a predetermined style feature. In an example, the style description information may be, for example, text including keywords such as “cute” and “cool”. The contrastive language-image pre-training model may efficiently determine whether the image is matched with the text. In addition, the predetermined style feature and the perceptual feature may be determined by the same contrastive image-text pre-training model, and the matching degree between the predetermined style feature and the perceptual feature may be improved after the difference between the predetermined style feature and the perceptual feature is adjusted, so as to generate a three-dimensional virtual character that is more in line with the style description information.

In some embodiments, the plurality of points of the initial three-dimensional virtual character are converted into the frequency domain, so that various 3D tools may be used for processing based on the plurality of frequency domain points. For example, the 3D tool may be a Unity 3D tool.

In some embodiments, the above-mentioned predetermined condition may be that the difference value is converged.

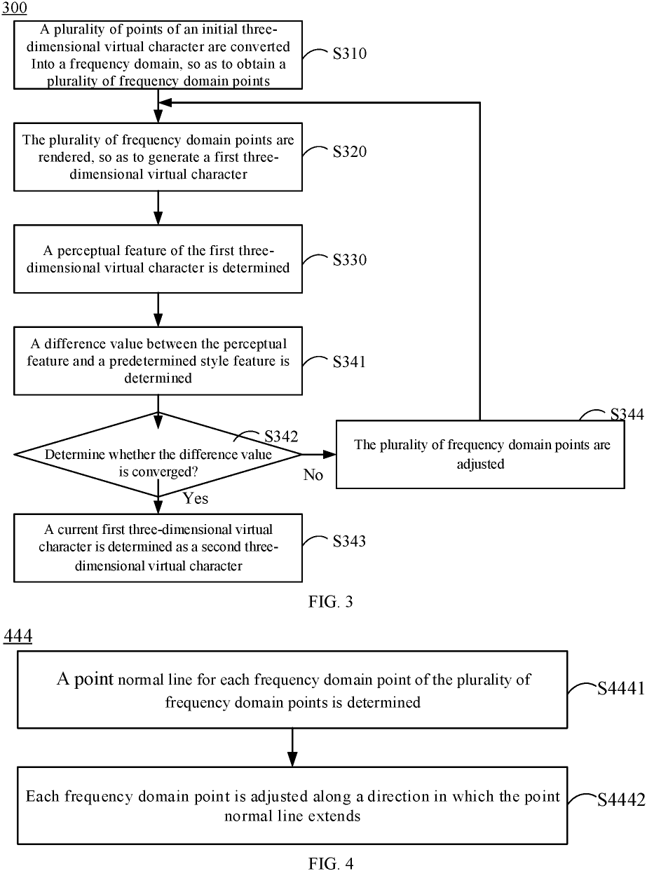

FIG. 3 is a flowchart of a method for generating a virtual character according to another embodiment of the present disclosure.

As shown in FIG. 3, the method 300 may include operation S310 to operation S330, and operation S341 to operation S344.

In operation S310, a plurality of points of an initial three-dimensional virtual character are converted into a frequency domain, so as to obtain a plurality of frequency domain points.

For example, the operation S310 is the same as or similar to the operation S210 described above, which will not be repeated here.

In operation S320, the plurality of frequency domain points are rendered, so as to generate a first three-dimensional virtual character.

For example, the operation S320 is the same as or similar to the operation S220 described above, which will not be repeated here in the present disclosure.

In operation S330, a perceptual feature of the first three-dimensional virtual character is determined.

For example, the perceptual feature of the first three-dimensional virtual character may be determined by using the above-mentioned contrastive image-text pre-training model.

In operation S341, a difference value between the perceptual feature and a predetermined style feature is determined.

For example, the predetermined style feature is determined based on style description information by using the above-mentioned contrastive image-text pre-training model.

For example, L2 loss function may be used to determine the difference value between the perceptual feature and the predetermined style feature. L2 loss function is also known as Least Square Error (LSE) loss function.

In operation S342, it is determined whether the difference value is converged.

In the embodiments of the present disclosure, in a case of determining that the difference value is converged, operation S343 is performed.

For example, if it is determined that an n-th difference value is less than or equal to a predetermined difference threshold, and then determined that i difference values after the n-th difference value are all less than or equal to the predetermined difference threshold, it may be determined that the difference value is converged. In an example, n is an integer greater than or equal to 1, and i is an integer greater than or equal to 1. For example, i is a preset value, i=1.

In the embodiment of the present disclosure, if it is determined that the difference value is not converged, operation S344 is performed and then the process is returned to operation S320.

For example, if it is determined that a m-th difference value is less than or equal to a predetermined difference threshold, and then determined that any one of j difference values after the m-th difference value is greater than the predetermined difference threshold, it may be determined that the difference value is not converged, and operation S344 may be performed. After the operation S344 is performed, the process may be returned to operation S320. In an example, m is an integer greater than or equal to 1, and j is an integer greater than or equal to 1. For example, j is a preset value, j=1.

In operation S343, a current first three-dimensional virtual character is determined as a second three-dimensional virtual character.

For example, as described above, after determining that the difference value is converged, the first 3D virtual character Vir_n corresponding to the n-th difference value may be determined as the second 3D virtual character.

In operation S344, the plurality of frequency domain points are adjusted.

For example, as described above, after determining that the difference value is not converged, a plurality of frequency domain points corresponding to a (m+j)-th difference value may be adjusted, so as to obtain a plurality of adjusted frequency domain points. The process is returned to the operation S320 for the plurality of adjusted frequency domain points, in which the plurality of adjusted frequency domain points are rendered, to generate a (m+j+1)-th first three-dimensional virtual character. Then subsequent operations are performed.

For example, the point has a point coordinate and a color. In an example, the frequency domain point has a frequency domain point coordinate and a frequency domain color.

In the embodiments of the present disclosure, in a case that the difference value is not converged, the frequency domain point(s) is/are adjusted until the difference value is converged, so that the perceptual feature of the second three-dimensional virtual character matches the predetermined style feature, thereby improving the user experience.

In some embodiments, different from the method 300, the difference value may be compared with a preset difference threshold to determine whether the difference value is converged.

For example, in a case that the n-th difference value is less than or equal to the preset difference threshold, it is determined that the difference value is converged.

As another example, in a case that the n-th difference value is greater than the preset difference threshold, it is determined that the difference value is not converged.

FIG. 4 is a flowchart of a method for generating a virtual character according to another embodiment of the present disclosure.

As shown in FIG. 4, the method 444 may adjust a plurality of frequency domain points, which will be described in detail in conjunction with operation S4441 to operation S4442 below.

In operation S4441, a point normal line is determined for each frequency domain point of the plurality of frequency domain points.

For example, a mesh (Mesh) model Model_Mesh_k may be determined based on the plurality of frequency domain points by using a Unity 3D tool. The mesh model Model_Mesh_k contains a plurality of triangular plane patch sub-models. In an example, one triangular planar patch sub-model may correspond to one frequency domain point. In an example, a three-dimensional virtual character may be obtained by rendering according to the mesh model Model _Mesh _k.

In operation S4442, each frequency domain point is adjusted along a direction in which the point normal line extends.

For example, as mentioned above, the frequency domain point has the frequency domain point coordinate and the frequency domain point color. A value of the frequency domain point coordinate may be adjusted along the direction in which the point normal line extends.

For example, after adjusting the value of the point coordinate along the direction in which the point normal line extends, an adjusted mesh model Model_Mesh_k+1 may be obtained, where k is an integer greater than or equal to 1.

In an example, the mesh model Model_Mesh_k+1 is rendered by using a renderer to obtain a first three-dimensional virtual character after the (k+1)-th adjustment. Adjusting along the direction in which the point normal line extends may ensure that each frequency domain point moves within a certain range, so that a distribution of adjusted frequency domain point is more uniform.

In some embodiments, adjusting the plurality of frequency domain points may include: adjusting a value of each frequency domain color.

In some embodiments, a data structure of the mesh model may be a graph structure. Accordingly, the mesh model may include a plurality of points, a plurality of edges, and a plurality of faces.

For example, the data structure of the mesh model may be a directed graph structure. For another example, the data structure of the mesh model may be an undirected graph structure.

In some embodiments, the point normal line may be a vertex normal line.

For example, face domain normal lines for vertexes of the triangular planar patch may be weighted and averaged to obtain the vertex normal.

In some embodiments, different from the method 400, adjusting the plurality of frequency domain points includes: a face point normal line is determined according to a plurality of frequency domain points; and the plurality of frequency domain points are adjusted along a direction in which the face point normal line extends.

For example, a face may be determined according to at least one triangular planar patch. The face point normal line may represent a vertex within a face rather than a vertex of a mesh model. A relationship between the face normal line and the mesh vertex is a many-to-one relationship. For example, a corner point in a cube mesh model has three perpendicular adjacent faces. The face point normal line may be determined according to the three perpendicular adjacent faces.

FIG. 5 is a block diagram of an apparatus for generating a virtual character according to an embodiment of the present disclosure.

As shown in FIG. 5, the apparatus 500 may include a converting module 510, a rendering module 520, a first determining module 530, and a generating module 540.

The converting module 510 is configured to convert a plurality of points of an initial three-dimensional virtual character into a frequency domain, so as to obtain a plurality of frequency domain points. In an example, the converting module 510 may be used to perform, for example, operation S210 in FIG. 2.

The rendering module 520 is configured to render the plurality of frequency domain points, so as to generate a first three-dimensional virtual character. In an example, the rendering module 520 may be used to perform, for example, operation S220 in FIG. 2.

The first determining module 530 is configured to determine a perceptual feature of the first three-dimensional virtual character. In an example, the first determining module 530 may be used to perform, for example, operation S230 in FIG. 2.

The generating module 540 is configured to generate a second three-dimensional virtual character according to a difference between the perceptual feature and a predetermined style feature. In an example, the first determining module 540 may be used to perform, for example, operation S240 in FIG. 2.

In some embodiments, the generating module includes: a first determining sub-module configured to determine a difference value between the perceptual feature and the predetermined style feature; a second determining sub-module configured to determine whether the difference value is converged; an obtaining sub-module configured to determine a current first three-dimensional virtual character as the second three-dimensional virtual character, in a case of determining that the difference value is converged; and an adjusting sub-module configured to adjust the plurality of frequency domain points and returning to the rendering the plurality of frequency domain points, in a case of determining that the difference value is not converged.

In some embodiments, the point has a coordinate and a color.

In some embodiments, the adjusting sub-module includes: a determining unit configured to determine a normal line of the each frequency domain point for each of the plurality of frequency domain points; and an adjusting unit configured to adjust the each frequency domain point data along a direction in which the normal line extends.

In some embodiments, the first determining module is configured to: process the first three-dimensional virtual character by using a contrastive language-image pre-training model, so as to obtain the perceptual feature of the first three-dimensional virtual character.

In some embodiments, the apparatus 500 further includes: a second determining module configured to determining, by using a contrastive language-image pre-training model, the predetermined style feature according to a style description information.

Acquiring, storing, applying, processing, transforming, providing and disclosing of the relevant data involved in the present disclosure comply with the provisions of relevant laws and regulations, and do not violate public order and good customs.

According to the embodiments of the present disclosure, the present disclosure also provides an electronic device, a readable storage medium, and a computer program product.

For example, the present disclosure also provides an electronic device, including: at least one processor; and a memory communicatively connected with the at least one processor; wherein the memory stores instructions executable by the at least one processor, and the instructions, when executed by the at least one processor, cause the at least one processor to perform the above-mentioned method.

For example, the present disclosure also provides a non-transitory computer-readable storage medium storing computer instructions is provided, wherein the computer instructions are configured to cause the computer to perform the above-mentioned method.

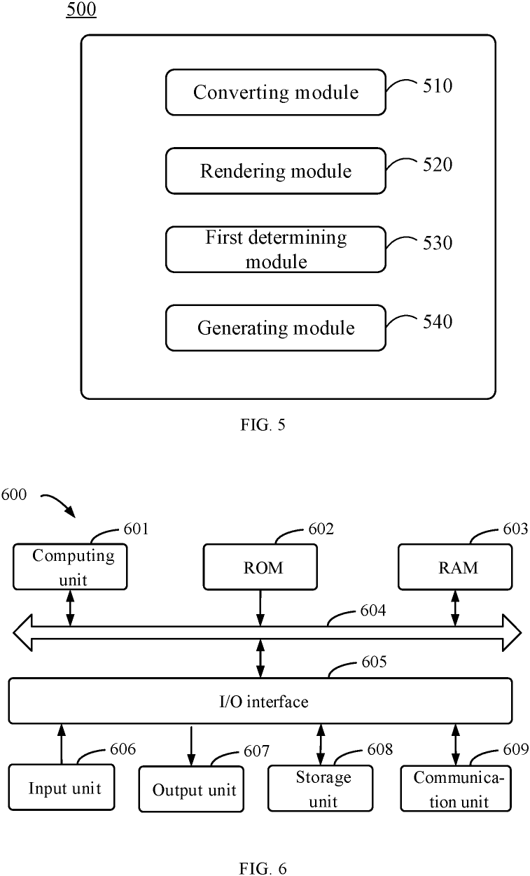

For example, the present disclosure also provides a computer program product including a computer program is provided, wherein the computer program, when executed by a processor, implements the above-mentioned method. The following will describe in detail with reference to FIG. 6.

FIG. 6 shows a schematic block diagram of an example electronic device 600 used to implement the embodiments of the present disclosure. The electronic device is intended to represent various forms of digital computers, such as laptop computers, desktop computers, workstations, personal digital assistants, servers, blade servers, mainframe computers and other suitable computers. The electronic device may also represent various forms of mobile devices, such as personal digital processing, cellular phones, smart phones, wearable devices and other similar computing devices. The components shown herein, their connections and relationships, and their functions are merely examples, and are not intended to limit the implementation of the present disclosure described and/or required herein.

As shown in FIG. 6, the device 600 includes a computing unit 601, which may execute various appropriate actions and processing according to a computer program stored in a read only memory (ROM) 602 or a computer program loaded from a storage unit 908 into a random access memory (RAM) 603. Various programs and data required for the operation of the device 600 may also be stored in the RAM 603. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and steps described above, such as the method for generating a virtual character. For example, in some embodiments, the method for generating a virtual character may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method for generating a virtual character described above. Alternatively, in other embodiments, the computing unit 601 may be configured to perform the method for generating a virtual character by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for generating a virtual character, comprising:
converting a plurality of points of an initial three-dimensional virtual character into a frequency domain, so as to obtain a plurality of frequency domain points;
rendering the plurality of frequency domain points, so as to generate a first three-dimensional virtual character;
determining a perceptual feature of the first three-dimensional virtual character; and
generating a second three-dimensional virtual character according to a difference between the perceptual feature and a predetermined style feature.

2. The method according to claim 1, wherein the generating a second three-dimensional virtual character according to a difference between the perceptual feature and a predetermined style feature comprises:
determining a difference value between the perceptual feature and the predetermined style feature;
determining whether the difference value is converged;
determining a current first three-dimensional virtual character as the second three-dimensional virtual character, in a case of determining that the difference value is converged; and
adjusting the plurality of frequency domain points and returning to the rendering the plurality of frequency domain points, in a case of determining that the difference value is not converged.

3. The method according to claim 1, wherein the point has a coordinate and a color.

4. The method according to claim 3, wherein the adjusting the plurality of frequency domain points comprises: for each of the plurality of frequency domain points,
determining a normal line of the each frequency domain point; and
adjusting the each frequency domain point data along a direction in which the normal line extends.

5. The method according to claim 2, wherein the determining a perceptual feature of the first three-dimensional virtual character comprises:
processing the first three-dimensional virtual character by using a contrastive language-image pre-training model, so as to obtain the perceptual feature of the first three-dimensional virtual character.

6. The method according to claim 1, further comprising:
determining, by using a contrastive language-image pre-training model, the predetermined style feature according to a style description information.

7. An electronic device, comprising:
at least one processor; and
a memory communicatively connected with the at least one processor;
wherein the memory stores instructions executable by the at least one processor, and the instructions, when executed by the at least one processor, cause the at least one processor to perform the method of claim 1.

8. The electronic device according to claim 7, wherein the at least one processor is further configured to:
determine a difference value between the perceptual feature and the predetermined style feature;
determine whether the difference value is converged;
determine a current first three-dimensional virtual character as the second three-dimensional virtual character, in a case of determining that the difference value is converged; and
adjust the plurality of frequency domain points and returning to the rendering the plurality of frequency domain points, in a case of determining that the difference value is not converged.

9. The electronic device according to claim 7, wherein the point has a coordinate and a color.

10. The electronic device according to claim 9, wherein the at least one processor is further configured to: for each of the plurality of frequency domain points,
determine a normal line of the each frequency domain point; and
adjust the each frequency domain point data along a direction in which the normal line extends.

11. The electronic device according to claim 8, wherein the at least one processor is further configured to:
process the first three-dimensional virtual character by using a contrastive language-image pre-training model, so as to obtain the perceptual feature of the first three-dimensional virtual character.

12. The electronic device according to claim 7, wherein the at least one processor is further configured to:
determine, by using a contrastive language-image pre-training model, the predetermined style feature according to a style description information.

13. A non-transitory computer-readable storage medium storing computer instructions, wherein the computer instructions are configured to cause the computer to perform the method of claim 1.

14. The storage medium according to claim 13, wherein the computer instructions are further configured to cause the computer to:
determine a difference value between the perceptual feature and the predetermined style feature;
determine whether the difference value is converged;
determine a current first three-dimensional virtual character as the second three-dimensional virtual character, in a case of determining that the difference value is converged; and
adjust the plurality of frequency domain points and returning to the rendering the plurality of frequency domain points, in a case of determining that the difference value is not converged.

15. The storage medium according to claim 13, wherein the point has a coordinate and a color.

16. The storage medium according to claim 15, wherein the computer instructions are further configured to cause the computer to: for each of the plurality of frequency domain points,
determine a normal line of the each frequency domain point; and
adjust the each frequency domain point data along a direction in which the normal line extends.

17. The storage medium according to claim 14, wherein the computer instructions are further configured to cause the computer to:
process the first three-dimensional virtual character by using a contrastive language-image pre-training model, so as to obtain the perceptual feature of the first three-dimensional virtual character.

18. The storage medium according to claim 13, wherein the computer instructions are further configured to cause the computer to:
determine, by using a contrastive language-image pre-training model, the predetermined style feature according to a style description information.
